(19) United States
(12) Patent Application Publication
(10) Pub. No.: US 2023/0256586 A1
(43) Pub. Date: Aug. 17, 2023

(54) Hand Grip for Tools

(71) Applicants: Jongmuk Kim, Busan (KR); Seungtaek Kim, Busan (KR)

(72) Inventors: Jongmuk Kim, Busan (KR); Seungtaek Kim, Busan (KR)

(21) Appl. No.: 17/963,144

(22) Filed: Oct. 10, 2022

(30) Foreign Application Priority Data
Feb. 11, 2022 (KR) 10-2022-0018301

(51) Int. Cl. B25G 3/20

(52) U.S. Cl. CPC B25G 3/20; B26B 5/00

(57) ABSTRACT

The present invention provides a hand grip for tools comprising: a body having a port that is formed on one side of the body and that a toolhead serving as one part of a tool is inserted into by connecting with the hand grip; and a coupler installed inside the body and fixing the toolhead to the port in a removable way. Therefore, the hand grip for tools according to the present invention features a connected structure that allows stable and convenient assembly and disassembly and quick replacements of the toolheads with simple movements.

### PRIORITY

This application claims priority under 35 U.S.C. § 119(a) to Korean Application Serial No. 10-2022-0018301, which was filed in the Korean Intellectual Property Office on Feb. 11, 2022, the entire disclosure of which is incorporated herein by reference.

### FIELD OF THE INVENTION

The present invention relates to a hand grip for tools, or more specifically, a universal hand grip for tools that is applicable to a wide variety of tools.

### BACKGROUND OF THE INVENTION

The work tools utilized in carpentry or construction can generally be classified into hand tools or power tools. In both tool types, the tool is composed of a grip part and a working part, with one end of the working part conjoined to the grip part. For example, a saw, which is a hand tool, is composed of a working part (blade) and a grip part (handle) and is used by conjoining the blade to the handle, thus forming a singular tool. Such work tools suffer from significant drops to their efficiency when the working part of the tool becomes worn out or damaged. It is generally the case that, in such cases, the entire tool is replaced, or just the working part is replaced. In the case of the aforementioned saw, bolts and other fasteners are inserted into holes formed at one end of the blade, effectively fixing the blade onto the handle. The blade is fixed depending on its connection to the handle. When replacing the blade, the fasteners must be removed from the interconnected tool parts, then the preexisting blade must be removed. After, the new blade must be attached, then fixed to the handle, once again using fasteners. However, this traditional method of replacing the working part of the tool poses problems, such as the need to utilize separate tools to disassemble the preexisting working part from the handle and to unfasten the fasteners. Another problem is that the replacement process, of unfastening the fasteners and reattaching the fasteners after the new working part is implemented, is extremely inconvenient and takes up a lot of time. Moreover, to stably fix the working part to the grip part, the parts must be fastened at a minimum of two disparate locations, requiring multiple fasteners and therefore reducing efficiency of the replacement operation. Such replacement methods significantly lower work efficiency, particularly for tools that require a single hand grip to be used for tools of various sizes and types. Furthermore, the traditional method of fastening the different parts of a tool together using bolt-type fasteners poses the following problem: using excessive force when exchanging a tool part or repeatedly exchanging tool parts leads to stripping of the bolt holes on the grip part or of the bolt fasteners. In extreme cases, the tools may no longer be conjoined, limiting the use of said tool.

This invention has been devised to solve the aforementioned problems. The purpose of this invention is to provide a hand grip for tools that allows for convenient, quick assembly and disassembly of the working part of the tool from the grip part without the need for separate tools and that allows the working part to be fixed stably onto the grip part after the tool has been assembled. In other words, this invention provides a hand grip for tools that is not only configured in a way that allows for convenient assembly and disassembly, but also stability and quick replacement operations. Furthermore, this invention is provided in a way that does not utilize bolt-type fasteners for the working part and the grip part, thus making for a hand grip for tools whose fastening does not loosen from abrasions to the bolt thread. Also, this invention provides a universal hand grip for tools, capable of connecting to a wide variety of tools. In other words, this invention can provide a universal hand grip for tools to which working parts of a tool can be connected, provided the ends of the working parts are standardized. Moreover, this invention provides a hand grip for tools that makes it easy to hang or store the tool.

### PRIOR ART/PATENT APPLICATIONS

Republic of Korea Public Utility Model No. 20-2010-0005837 (Disclosed on Jun. 8, 2010)

### SUMMARY OF THE INVENTION

To achieve the aforementioned purposes, the hand grip for tools provided by this invention serves as a handle to which the toolhead on one end of a tool is attached. Installed within the body of the handle, and accessible from one side, is a port to which the toolhead is inserted, and this port comprises a coupler, which allows the toolhead to be fastened and removed. The coupler mentioned here comprises a fastener that connects with the toolhead, as well as an elastic body that is connected to the fastener to allow it to move and detach from the fastener. Furthermore, the fastener moves in a layer formation with the elastic body and comprises the base accommodated by the body of the handle, as well as the connecting pin that protrudes from one side of the base and fits the hole located on the toolhead. Also, the coupler comprises a recessed groove, which is layered with the fastener and is positioned to allow enough room to accommodate and facilitate the movements of the connecting pin, as well as a flat connector, which includes a socket to which the toolhead is inserted and which is located to one side of the recessed groove. The coupler also comprises a flat pressure plate which is layered with the connector and from which protrudes a push protrusion that exerts pressure onto the side of the toolhead inserted into the socket. Moreover, the coupler comprises the first spacer, a flat spacer which is positioned between the fastener and the connector and provides space to accommodate the movements of the connecting pin, as well as the second spacer, a flat spacer which is layered with the pressure plate and provides space to accommodate the movements of the push protrusion. On the other hand, the body of the handle comprises the first housing, on one side of which the first opening, which divides a part of the port, is located, as well as the second housing, on one side of which the second opening, which divides the remaining part of the port and opposes the first opening, is located. Each housing is open on one side due to the port, with this opening extending from the port, and comprises a casing that separates and configures the space in which the coupler is to be installed. The casing comprises a concave pocket that houses the fastener and the elastic body. Furthermore, the fastener also comprises a release pin, which protrudes from the base, is spaced apart from the connecting pin, and has a section that protrudes outside of the body of the handle. The length of the release pin is longer than the length of the connecting pin. Moreover, the body of the handle also comprises a release button, which is installed on the exterior of the body of the handle, is connected to the release pin, and moves the fastener when external force is exerted on the button. Lastly, the body of the handle consists of a flat bottom surface located on the opposite side of the port. A magnet is attached to this flat surface, allowing objects to stick to the surface via magnetism.

As described above, the hand grip for tools related to this invention allows not only for convenient and quick assembly and disassembly when assembling or disassembling the working part of the tool from the grip part without additional tools, but also for the stable fixation of the working part to the grip part after they have been assembled. The hand grip for tools related to this invention here is not only configured in a way that allows for convenient assembly and disassembly, but also stability and quick replacement operations. Furthermore, this invention is provided in a structure which does not utilize bolt-type fasteners for the working part and the grip part but rather, a pin structure, thus helping prevent the fastening from loosening due to abrasions to the bolt thread. Also, this invention provides a universal hand grip for tools, capable of connecting to a wide variety of tools. In other words, this invention can provide a universal hand grip for tools to which working parts of a tool can be connected, provided the ends of the working parts are standardized. Furthermore, this invention features a handle body whose bottom surface is fitted with a magnet, allowing the tool to be conveniently placed or stored via magnetism.

### BRIEF DESCRIPTION OF THE DRAWINGS

FIG. 1 is a perspective view schematically illustrating a hand grip for tools according to an embodiment of the present invention.

FIG. 2 is a magnified perspective view illustrating the main components of the hand grip for tools in a state of being connected to a toolhead according to the embodiment of the present invention.

FIG. 3 is a magnified perspective view illustrating the main components of the hand grip for tools in a state of being disconnected to a toolhead according to the embodiment of the present invention.

FIG. 4 is an exploded perspective view schematically illustrating the hand grip for tools according to an embodiment of the present invention.

FIG. 5 is a magnified perspective view illustrating a part of the hand grip for tools according to the embodiment of the present invention.

FIG. 6 is a cross-sectional view illustrating the hand grip for tools when the toolhead is disassembled according to the embodiment of the present invention.

FIG. 7 is a cross-sectional view illustrating the hand grip for tools while a button is being pressed to allow the toolhead to be connected to the handgrip according to the embodiment of the present invention.

FIG. 8 is a cross-sectional view illustrating the hand grip for tools when the toolhead is connected to the handgrip according to the embodiment of the present invention.

### DETAILED DESCIPTION EMBODIEMENTS OF THE INVENTIONS

Hereinafter, preferred embodiments according to the present invention will be described in detail in conjunction with the accompanying drawings.

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

In addition, as used in the specification including the appended claims, the singular forms “a,” “an,” and “the” include the plural, and reference to a particular numerical value includes at least that particular value, unless the context clearly dictates otherwise.

The features and attendant advantages of the present invention, as well as the solutions to achieve said features and advantages, will become clearer when considered in conjunction with the accompanying drawings and the real-life examples described hereafter. The present invention, however, is not limited to the real-life examples mentioned below; rather, the invention will be realized in various disparate ways. The technical features of the present invention will be explicated in detail below, accompanied by the attached figures.

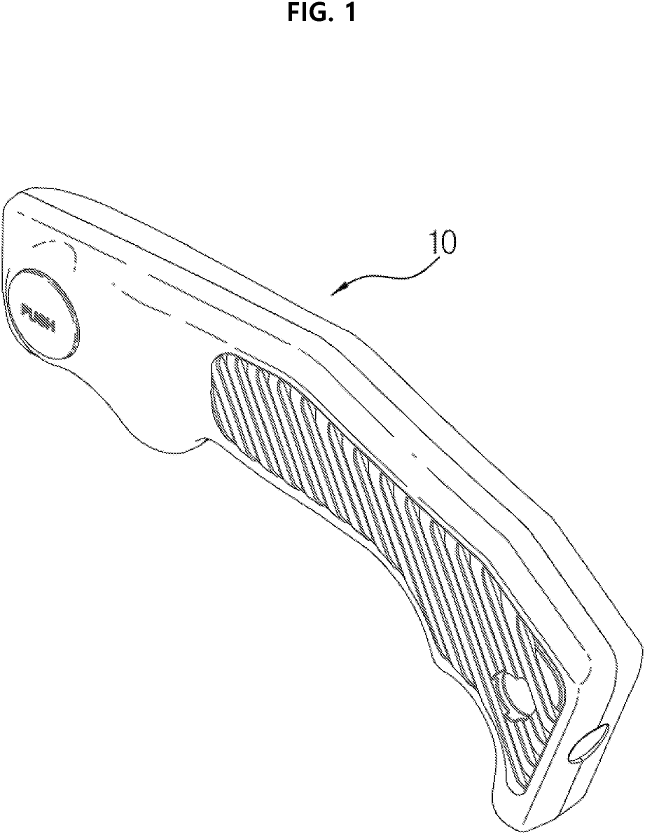

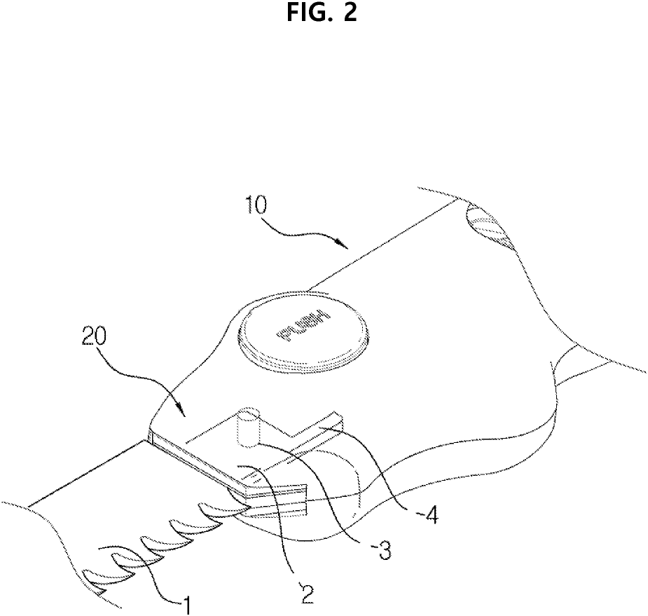

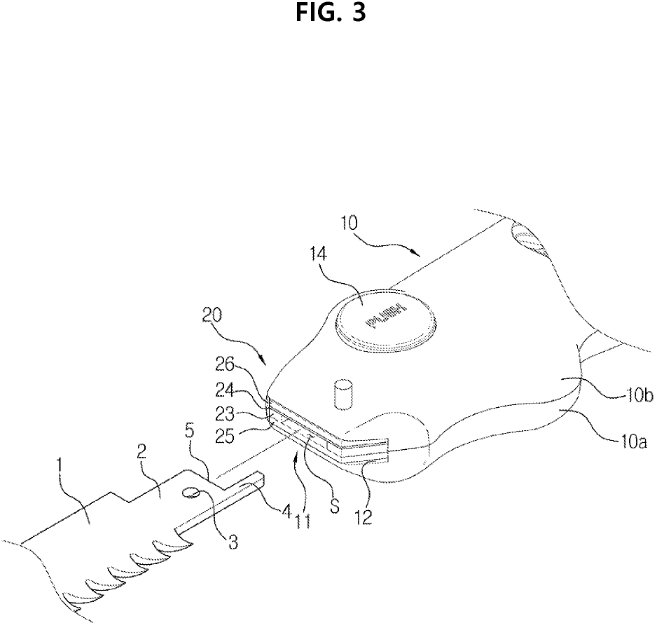

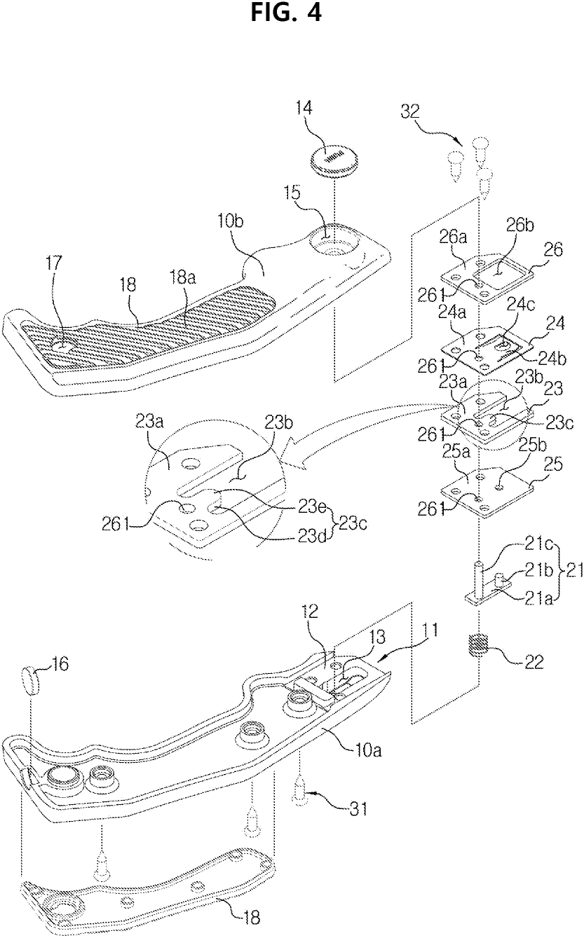

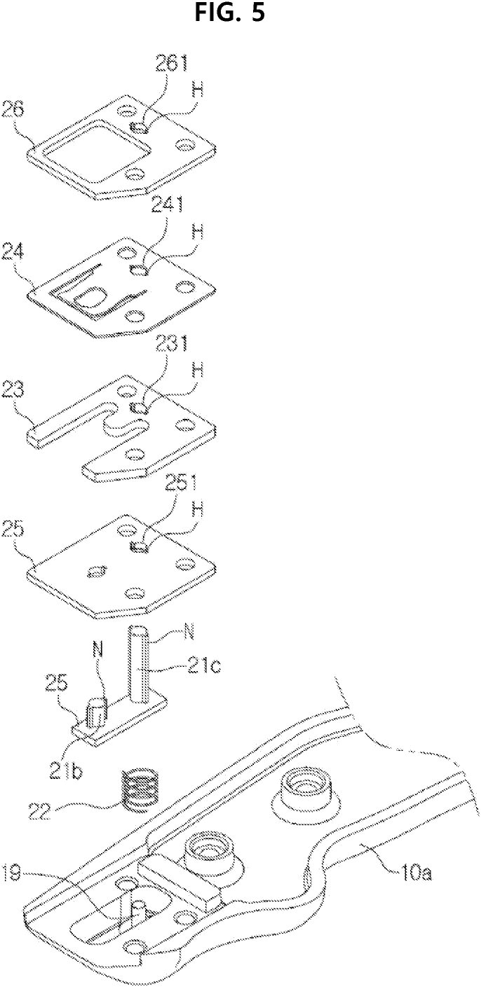

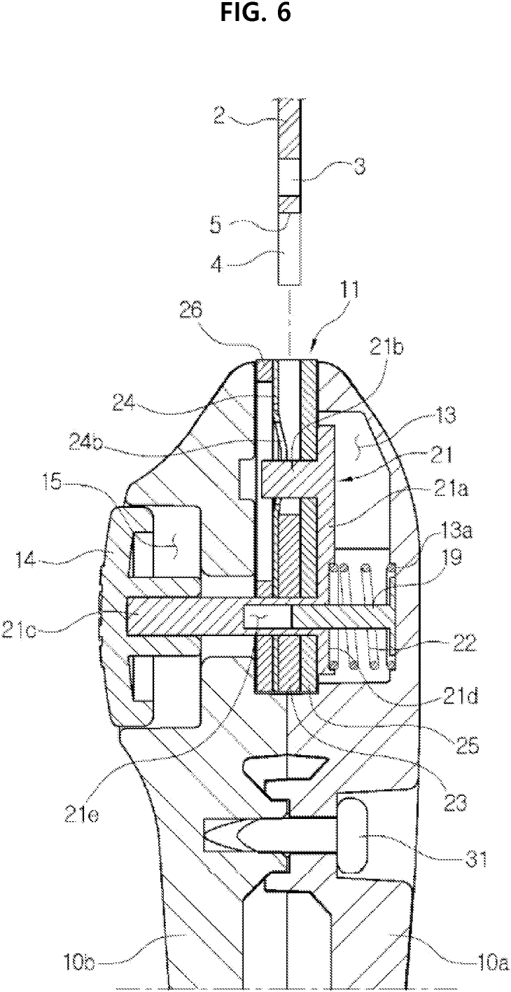

FIG. 1 is a perspective view schematically illustrating a hand grip for tools according to an embodiment of the present invention. FIGS. 2 and 3 are magnified perspective views illustrating the main components of the hand grip for tools in a state of being connected and being disconnected to a toolhead according to the embodiment of the present invention. FIG. 4 is an exploded perspective view schematically illustrating the hand grip for tools according to an embodiment of the present invention. FIG. 5 is a magnified perspective view illustrating a part of the hand grip for tools according to the embodiment of the present invention. FIGS. 6 to 8 are cross-sectional views illustrating the hand grip for tools from when toolhead is disassembled to when the toolhead is connected to the handgrip according to the embodiment of the present invention.

Referring to FIGS. 1 to 8, a hand grip for tools, based on the embodiment of the present invention, refers to the grip part that connects with the toolhead located on one side of the working part that makes up the tool. The hand grip for tools comprises the following: the body of the handle or the hand grip (10) on one side of which is located a port (11) into which the toolhead (2) of the tool (1) will be inserted, as well as the coupler (20) which is installed within the body of the handle (10) and allows for the connection and fixation of the toolhead (2). In this embodiment of the present invention, the hand grip for tools, which is the present invention, acts as the grip part and connects with the working part to function together as a singular tool, following the fixation of the toolhead (2), which is located on one side of the working part and is inserted into the body of the handle (10) and fixed by the coupler (20).

The aforementioned toolhead (2) is part of the working part of the tool and is exemplified by the cut end of a saw blade. Aside from that, the toolhead (2) can also be a component of the working parts of common hand tools such as box cutters, hammers, axes, and screwdrivers, as well as those of power tools to which tools are attached; in particular, any tool with replaceable working parts feature a toolhead (2). Here, the toolhead (2) can be formed using a universal design so that it can be stably connected to the present invention, the hand grip for tools. The toolhead (2) is not limited by the size or type of the tool and must be shaped on one end so that it fits into the hand grip for tools defined by the present invention.

In other words, the toolhead (2) must be formed in such a way that the fixing hole (3) and the connecting protrusion (4) are uniform in their size, position, and other external factors so that different types of tools can be fitted and replaced onto a single hand grip for tools for use. For example, the toolhead (2) can have a uniformly defined width, direction, and length and can have the appearance of a bar that extends from the working part, with a fixing hole (3) positioned slightly apart from the cut end and a connecting protrusion (4) protruding from one side of the cut end.

The body of the handle (10) defined by the present invention can be shaped like a handle that can be grabbed, as drawn in FIGS. 1 to 3, and on one end features a port (11) into which the toolhead (2) can be inserted. The toolhead (2) inserted into the port (11) can be fixed in a way such that the toolhead (2) can be separated via the coupler (20).

The port (11), which will be explained in further detail below, can be formed in an open manner as to help guide the toolhead (2) as it is inserted, so that the toolhead (2) can be fixed by the coupler (20) which will be installed on the body of the handle (10).

Here, the body of the handle (1) is open on one side due to the port (11) as is described by FIGS. 3 to 6 and comprises a casing (12) that provides space in the interior of the body of the handle (10). The casing (12) is formed in a way that extends from the port (11) and can form and accommodate space for the coupler (20) to be installed. Such a casing (12) can comprise the pocket (13) which is formed to one side of the casing (12).

The pocket (13) can be concavely formed on the casing (12) to accommodate the fastener (21) and the elastic body (22) of the coupler (20), which will be explained in further detail below.

Furthermore, the exterior of the body of the handle (10) can accommodate a release button (14), via which the connection status of the coupler (20) can be switched. The body of the handle (10) also features a button installation hole (15) which connects to the release button (14) in a way that allows the release button (14) to move or operate. The button installation hole (15) may possibly be equipped with a lock button (not depicted), which can temporarily fix the release button (14) in place. This lock button can prevent the release button (14) from being accidentally or arbitrarily pressed. In other words, the hand grip for tools can feature a lock button, which is installed in a protruding structure that allows for the lock button to be connected or separated to one direction of the release button (14) in a sliding manner. The lock button allows the operator an optional locking function for the release button (14) and prevents the release button (14) from being randomly pressed while the hand grip is in use.

On the other hand, the body of the handle (10) can be formed in a way that comprises the first housing (10a) and the second housing (10b) as shown in FIGS. 3 to 6. In the embodiment of the present invention, the first housing (10a) and the second housing (10b) is shaped into a frame that provides the port (11) on one side and each half of the casing (12), with each housing positioned on the lower and upper parts respectively. When the two housings (10a, 10b) are mutually fixed, they can be used as a single grip for the handle or, in other words, the grip part. For example, the housings on either side (10a, 10b) can be mutually fixed by the primary fixed member (31), which is composed of a fixing bolt as shown in FIG. 6.

Here, the pocket (13) is formed on the first housing (10a) of the body of the handle (10), and on the second housing (10b) can be formed the button installation hole (15) and the release button (14).

The coupler (20) featured in the present invention comprises a fastener (21) and an elastic body (22) as shown in FIGS. 4 to 6. The coupler (20) can also comprise at least one layer member, which connects with the fastener (21) in layers. The layer members, as will be described hereafter, comprise the connector (23), the pressure plate (24), the first spacer (25), and the second spacer (26). The layer members can be fixed in place by the secondary fixing unit (32) onto the body of the handle (10).

First, the fastener (21) is formed as a layered member and is installed onto the body of the handle (10) in a way that allows the fastener (21) to remain movable. The fastener (21) is accommodated by the pocket (13) located in the body of the handle (10) and is moved by the elastic body (22). The fastener (21), depending on whether it has been moved, can be switched between being connected to or separated from the toolhead (2) inserted into the body of the handle (10).

Furthermore, the elastic body (22) can be connected to the fastener (21). Here, the elastic body (22) can be installed in the pocket (13) of the body of the handle (10) as a layer underneath the fastener (21). The elastic body (22) can be mechanically connected or mutually fixed to the fastener (21), but the fastener (21) and the elastic body (22) can also be positioned in a way that the two component merely come into contact with one another. For example, the lower side of the fastener (21) can feature a spring groove (21d) that can partially accommodate the upper part of the elastic body (22). The fastener can be stably supported via a method in which the elastic body (22) is partially inserted into the spring groove (21d). Moreover, the elastic body (22) can also be supported via a partial accommodation of the elastic body (22) by the spring groove (13a) located in the pocket (13). The elastic body (22) can move the fastener (21), allowing it to disconnect from the toolhead (2). The elastic body (22) can consist of a material that provides a small amount of elasticity; for example, the elastic body (22) can be made of a compression coil spring. Furthermore, the elastic body (22) supports the fastener (21) in a way that allows the fastener (21) to move. The elastic body (22) elastically supports the fastener (21) within the handle body (10) and, depending on externally applied forces, can expand or retract, moving the fastener (21) along with the movements. In other words, the elastic body (22) shrinks when external force is applied, moving the fastener (21) downward; when the external force is no longer applied, elasticity is restored to the elastic body (22), allowing it to expand and move the fastener (21) upward along with it, thus elastically supporting the fastener (21). Moreover, the elastic body (22) is shown to be positioned towards the fastener (21). In other words, the elastic body (22) is positioned towards the release button (14) in a way that the two are in opposing positions. This is so that the elasticity supplied by the fastener (21), and in turn by the release button (14), can be directly applied from the opposing position. On the other hand, the elastic body (22) can also be positioned towards the middle of the fastener (21) or can be positioned apart from additional elastic bodies (not depicted).

As explained previously, the fastener (21) can connect to the elastic body (22) in layers, supported by the elasticity provided by the elastic body (22) and capable of moving upward with respect to the toolhead (2).

Here, the fastener (21) can comprise the base (21a) and the connecting pin (21b) as depicted in FIGS. 4 to 6. The base (21a) can be formed as a layered member and stacked on top of the elastic body (22). The base (21a) is supported by the elastic body (22) and can be accommodated by the pocket (13) of the body of the handle (10). The base (21a) can be moved upward or downward along the body of the handle (10) following the elastic body (22) as it shrinks and expands. The connecting pin (21b) is a pin-shaped material that protrudes from one side of the base (21a) and can be fitted into the fixing hole (3) located on the toolhead (2). The connecting pin (21b) can be positioned to protrude from the top side of the base (21a). As the elastic body (22) shrinks or expands from external forces applied to it, the connecting pin (21b) will also move alongside the base (21a) in such a way that the connecting pin (21b) is either fitted into the fixing hole (3) of the toolhead (2) or disconnected from it.

According to the hand grip for tools outlined in the embodiment of the present invention as explained above, the fastener (21) of the coupler (20) can be moved by the elastic body (22), and, depending on whether the connecting pin (21b) is connected to or disconnected from the toolhead (2), the working part and grip part of the tool can be conjoined or disconnected. The hand grip for tools outlined in the embodiment of the present invention is structured in a way that the toolhead (2) is connected with a pin via the coupler (20). The toolhead (2) can easily be fixed or disconnected without additional tools, and the structure of the grip in which a penetrating pin connects the disparate parts can prevent the toolhead (2) from arbitrarily breaking off or separating from the grip. Therefore, the coupler (20), as defined by the present invention, allows the toolhead (2) to be stably fixed to or disconnected from the body of the handle (10) via a simple movement that switches the connection status of the components; such a structure allows for convenient connection and disconnection of the parts and allows the working part of the tool to be quickly replaced onto the grip part.

On the other hand, the fastener (21) can comprise the release pin (21c) as depicted in FIGS. 4 to 6. The release pin (21c) can protrude from the based (21a), spaced apart from the connecting pin (21b). The release pin (21c) can be longer than the connecting pin (21b) and can extend so that a part of it is exposed outside of the body of the handle (10). A short end of the release pin (21c) can be connected to the release button (14) located in the handle of the body (10). In other words, the release pin (21c) can be pressed by an external force that is applied to the release button (14) and can function to move the fastener (21) so that the fastener (21) can exert pressure on the elastic body (22). In the process, the fastener (21) and the elastic body (22) move downward together, which moves the connecting pin (21b) downward, spacing the pin away from the fixing hole (3) on the toolhead (2), allowing the connecting pin (21b) to disconnect from the toolhead (2). Here, guide holes, which connect with the release pin (21c) may be formed on each layer member of the coupler (20). Depending on the insertion of the release pin (21c) onto the guide holes, the layer members can remain in a neatly organized fashion. The configuration of the guide holes will be explicated in further detail hereafter.

In a similar manner described above, the release pin (21c) is spaced apart from the connecting pin (21b) along the length of the toolhead (2); the two pins help form a connected structure among the layer members. Such a structure induces stable upward movements of the fastener (21) and stably fixes the toolhead (2) by supporting the layer members at the same time.

Referring back to FIGS. 4 to 6, the coupler (20) includes the connector (23). The connector (23) is formed as a layered member and can be connected to the fastener (21) in layers. The connector (23) guides the insertion of the toolhead (2) as it is inserted into the port (11) located on the body of the handle (10). Furthermore, the connector (23) can connect with the toolhead (2).

The connector (23) comprises the connector body (23a), the recessed groove (23b) located on the connector body (23a) into which the toolhead (2) is inserted, and the socket (23c) on the recessed groove (23b) into which the toolhead (2) is fitted.

The connector body (23a) is a layered member that, formed as the exterior of the connector (23). The connector body (23a) is formed to the corresponding thickness of the toolhead (2) and can be fitted with the upper part of the fastener (21) in layers. On the connector body (23a) is the first pin hole (231), which connects to the release pin (21c) of the fastener (21) in a penetrative manner. The first pin hole (231), as will be explained hereafter, is formed so as to correspond with pin holes on other layers into which the release pin (21c) is fitted. In this manner, the multiple layers can be aligned neatly.

The recessed groove (23b) is formed on one side of the connector body (23a) and is open, providing space for the toolhead (2) to move and be inserted into. For example, the recessed groove (23b) is formed so that it can be penetrated via the notch-type hole with respect to the connector body (23a). In other words, the recessed groove (23b) is formed as a groove whose length corresponds to the widthwise length of the toolhead (2) and is formed within the connector body (23a) on one side. This recessed groove (23b) guides the insertion of the toolhead (2), as it is positioned on the side of the body of the handle (10) and the port (11). Furthermore, the recessed groove (23b) prevents the toolhead (2) from moving widthwise, stably fixing the toolhead (2) in place. Moreover, the recessed groove (23b) provides movement space for the connecting pin (21b) so that the connecting pin (21b) of the fastener 921) can connect to the toolhead (2). In other words, the recessed groove (23b) is formed in an open manner and provides a small space which accommodates the connecting pin (21b) so as not to restrict its movement.

The socket (23c), into which the toolhead (2) can be fitted and connected, is formed on one side of the connector body (23a) on which the recessed groove (23b) is located. Here, the socket (23c) is formed in a way that corresponds to the shape of the short end of the toolhead (2); for example, the socket (23c) can comprise at least one indentation (23d) that fits with the connecting protrusion (4) that protrudes away from the short end of the toolhead (2). Furthermore, the socket (23c) can include the protuberance (23e) that protrudes close to the indentation (23d) and wraps around the connecting protrusion (4) of the toolhead (2). In other words, the socket (23c) can support the fitted connecting protrusions (4) of the toolhead (2) with the indentation (23d) and the protuberance (23e). Therefore, the socket (23c) can connect with the toolhead (2).

Here, the indentation (23d) of the socket (23c) can come in the form of a pair of grooves, each situated on either side of the protuberance (23e).

On the other hand, the connecting protrusions (4) of the toolhead (2) can be configured as a pair of mutually spaced protrusions that correspond with the pair of grooves, thus allowing the tool to maintain a more stable connection. In the same way, the connector (23) on the one hand guides the insertion of the toolhead (2) via the recessed groove (23b) and the socket (23c), effectively preventing movement, and on the other hand, the connector (23) can be fitted and connected independently to the toolhead (2) to fix it in place. Accordingly, as defined by the present invention, on top of the primary fixation that fixes the toolhead (2) in place via the fastener (21), the coupler (20) stably fixes the toolhead (2) in place via a secondary fixation by the connector (23).

Referring back to FIGS. 4 to 6, the coupler (20) comprises the pressure plate (24). The pressure plate (24) defined in the present invention connects with the connector (23) by stacking on top of it, hence exerting pressure on the toolhead (2) fitted into the connector (23) either from its upper or lower sides. For this purpose, the pressure plate (24) features push protrusions (24b) that protrude toward either the upper or lower sides of the plate body (24a).

For instance, the pressure plate (24) connects to connector (23) by stacking on top of the connector (23), and the push protrusions (24b) that protrude from the bottom side of the plate can exert pressure on one side of the toolhead (2). The push protrusions (24b) can be configured with either leaf springs or spiral springs. The push protrusions (24b) can feature a through hole (24c) through which the connecting pin (21b) penetrates. Push protrusions (24b) can exert pressure on a toolhead (2) that is connected to the connector (23). Here, the push protrusions (24b) exert pressure on the top side of the toolhead (2), which subsequently leads to the bottom side of the toolhead (2) to come into contact with either the casing (12) of the body of the handle (10) or the spacer, which will be explained hereafter. Such support on both sides of the toolhead (2) allow it to stay fixed stably. Furthermore, the pressure plate (24) can be formed in a position that corresponds to the location of the second pin hole (241), which is penetrated by and connects with the release pin (21c).

Meanwhile, the coupler (20) can comprise the first spacer (25), whose purpose is to provide space for the movement of the connecting pin (21b) as depicted in FIGS. 4 to 6. The first spacer (25) can consist of a very thin layer-type member and can be positioned between the fastener (21) and the connector (23). Here, the first spacer (25) can be placed in a way that it touches the casing (12) on one side and is supported by the casing (12). In other words, the first spacer (25) can be positioned to touch the lower side of the connector (23) and the opposing side of the casing (12) of the first housing (10a), effectively supporting the bottom side of the toolhead (2) that has been fitted into the connector (23) and helping guide the toolhead as it is inserted.

The first spacer (25) comprises a body (25a), as well as the first through hole (25b), which is located on the body (25a) and is pierced through by the connecting pin (21b), effectively limiting the space for the connecting pin (21b) to move. Furthermore, the first spacer (25) guides the movement of the connecting pin (21b). With the body (25a) of the first spacer (25) consisting of a uniform thickness, the first spacer (25) positions the connector (23) and the fastener (21) so that they are mutually spaced apart, hereby allowing the connecting pin (21b) to move an appropriate length of distance while it is being elevated and subsequently allowing the connecting pin (21b) enough space to properly connect or disconnect when the fastener (21) is pressed by the release button (14). Moreover, the first spacer (25) can prevent the movement of the fastener (21) as the connecting pin (21b) that connects with the toolhead (2) can be connected to the first through hole (25b), allowing for stable connections. Also, the first spacer (25) allows a part of the connecting pin (21b) to remain inside the first through hole (25b) even when the fastener (21) moves due to the release button (14) being pressed, thus preventing the connecting pin (21b) from deviating. Furthermore, the first spacer (25) can be located in a position that corresponds to the third pin hole (251) that is penetrated by and connected to the release pin (21c).

Moreover, the coupler (20) can comprise the second spacer (26), whose purpose is to provide space for the push protrusions (24b) to move, as depicted in FIGS. 4 to 6. The second spacer (26) consists of a very thin layered material and can be placed on top of connector (23) or the pressure plate (24). The second spacer (26) can comprise a body (26a) and an acting hole (26b) which is located on the body (26a) in an open manner so as to correspond to the formation of the push protrusions (24b). The second spacer (26) provides a small space for the push protrusions (24b) to act via the acting hole (26b). In other words, when the toolhead (2) is fitted onto the connector (23), the push protrusions (24b) on the pressure plate (24) exerts pressure on the toolhead (2) at the same time the protruding parts move upward. At this time, the aforementioned components do not limit the pressing movements of the pressure plate (24) as they allow the push protrusions (24b) to move via the acting hole (26b).

In addition, the second spacer (26) provides leeway for the connecting pin (21b) via the acting hole (26b), which is formed in an open manner. At this time, the second spacer (26) is positioned so that its opposite side touches the other side of the casing (12), allowing the second spacer (26) to be supported by the casing (12). In other words, the second spacer (26) can be positioned to touch the opposing side of the casing (12) of the second housing (10b), effectively supporting the top side of the toolhead (2) via the pressure plate (24) which is located on top of the connector (23). Furthermore, the second spacer (26) can be located in a position that corresponds to the fourth pin hole (261) that is penetrated by and connected to the release pin (21c). Meanwhile, the first spacer (25) and second spacer (26) mentioned previously are placed on the upper and lower sides of the connector (23) respectively, effectively closing off the either open sides of the recessed groove (23b) of the connector (23) and, along with the recessed groove (23b), composing a hole through which the toolhead (2) can be inserted. Here, the pressure plate (24) is located on the bottom side of the second spacer (26), which positions the second spacer (26) between the pressure plate (24) and the first spacer (25).

On the other hand, the opposite short end of the body of the handle (10) features a flat bottom side that is positioned in opposition to the port (11) as depicted in FIG. 4. The body of the handle (10) is able to stand on the ground. At this time, the bottom side of the body of the handle (10) can be fitted with a magnet (16).

The magnet (16) can consist of a magnetic material, allowing the body of the handle (10) to be placed perpendicular to any surface. The magnet (16) allows the body of the handle (10) to stick to a metal toolbox or a desk, for example. In other words, the body of the handle (10) allows for convenient storage of the hand grip.

The bottom surface of the body of the handle (10) may feature a magnet groove (not depicted) that accommodates the magnet (16). The magnet groove may be formed separately on the first casing (10a) and the second casing (10b).

Furthermore, the body of the handle (10) can include a strap hole (17) as depicted in FIG. 4. The strap hole (17) can be formed in the shape of a hole that pierces through the first housing (10a) and the second housing (10b) and can be placed close to the other side of the body of the handle (10). The strap hole (17) can connect with a hand strap (not depicted) that allows for easy carrying of the hand grip and can also connect with hooks and other apparatuses. Furthermore, the strap hole (17) allows the hand grip to be hung on the likes of hangers on walls and other small spaces, even without having to be connected to other materials, allowing the hand grip for tools defined by this invention to be stored conveniently.

Moreover, the body of the handle (10) can comprise a pair of rubber parts (18) which connect to the exterior of the first housing (10a) and the second housing (10b) as depicted in FIG. 4. The rubber parts (18) are connected each exterior of the housings, allowing the user to grip the item better. The rubber parts (18) function as cushions and can be made of a rubber material, as well as a wide variety of plastic material. The rubber parts (18) feature at least one groove (18a), which are designed to improve the grip of the item.

Furthermore, the body of the handle (10) comprises guide pins (19), which are installed on the pocket (13) as depicted in FIG. 6. The guide pins (19) rest on the spring grooves (13a) located in the pocket (13) and feature pin-shaped protrusions that protrude upward. These guide pins (19) are situated in a position that corresponds to the release pin (21c) of the fastener (21) and can be inserted into the guide grooves (21e) on the fastener (21). In other words, the guide pins (19) act to guide the upward movement of the fastener (21) as it is displaced by the elastic body (22) which is positioned toward the fastener (21).

On the other hand, the coupler (20) comprises the notch part (N) which protrudes from the exterior of the connecting pin (21b) or the release pin (21c) as depicted in FIG. 10. The notch part (N) is a protrusion with the purpose of preventing movement and can protrude on one side of the exterior following the lengthwise direction of each pin. The coupler (20) features notch grooves (H) on each of its members that correspond with the notch part (N). The notch part (N) consists of its individual pins (21b, 21c) that are formed on the exterior, and the notch grooves (H) are formed on the exterior of the pin holes (231, 241, 251, 261) of each layer member. At this time, the fixing hole (3) of the toolhead (2) also features a notch groove (3a) to correspond with the notch part (N) formed on the connecting pin (21b). In other words, the connected notch part (N) and notch grooves (H), according to the present invention, guide the upward movement of the fastener (21), prevent its movement in the horizontal rotational direction, helping maintain a stable, aligned state. In particular, the notch part (N) fits into the notch groove (3a) of the toolhead (2), improving the fastness of the item. For the connecting pin (21b), the notch part (N) protrudes on either side along the lengthwise direction of the toolhead (2). For the release pin (21c), the notch part (N) protrudes on either side along the widthwise direction of the toolhead. Therefore, the notch part (N) can steadfastly guide the upward movement of the fastener (21), given its protrusions in separate directions and effectively prevent the movement of the coupler (20), thus maintaining the stable connection of the components.

Furthermore, while not depicted in the figures, the top and the bottom of each layer member are characterized by concavo-convex surfaces that mutually correspond with each other. The concavo-convex surfaces mutually connect with each other between the layers, preventing lateral movement of the layer members and improving the stability of the components.

The foregoing applications and effects of the hand grip for tools for the embodiment of the present invention configured thus will now be explicated using the entirety of the figures. In the hand grip for tools in this present invention, the toolhead (2) that is inserted via the port (11) of the body of the handle (10) is fixed in place by the coupler (20), as depicted in FIGS. 2 and 3. The process in which the toolhead (2) is inserted into the body of the handle (10) and is set in place via the coupler (20) is depicted sequentially in FIGS. 6 to 8.

More specifically, the toolhead (2) of the tool to be replaced or mounted is inserted into the port (11) of the body of the handle (10). The port (11) built into one side of the body of the handle (10) consists of multiple layer members that are connected in layers, with space (S, refer to FIG. 3) for the insertion of the toolhead (2), allowing for the stable fixation of the toolhead (2) being inserted.

In other words, the space of insertion (S) is defined by the space of the port (11) and guides the toolhead (2) as it is inserted, preventing the working part of the tool from moving while in operation. The space of insertion (S) is formed through the layered structure of the layer members, and with the members remaining connected within the interior of the casing (12), the stability of the item increases. Here, the toolhead (2) is supported widthwise by the recessed groove (23b) of the connector (23).

The spacer (25) and the pressure plate (24) stacked within the connector (23) support the toolhead (2) from the top and the bottom, respectively, guiding the toolhead (2) as it is inserted. When the toolhead (2) is inserted into the port (11), the user can first press the release button (21) and continuously move the toolhead (2) while the fastener (21) has been disconnected. Then, once the toolhead (2) is fitted into the socket (23c) of the connector (23), the user can let go of the release button (14), rendering the component connected via the connecting pin (21b).

At this time, if the release button (14) is pressed through the location of the connecting pin (21b) at the moment the connecting pin (21b) comes into contact with the short end (5) of the toolhead (2), then the fastener (21) can connect with the connecting pin (21b) in the fixing hole (3) of the toolhead (2) due to the compressions of the elastic body (22), making it less uncomfortable for the user to press the release button (14).

On one hand, contrary to the present embodiment, if the length of the connecting pin (21b) was shortened and placed at an angle to the direction into which the toolhead (2) is to be inserted, such a configuration would allow the user to easily mount the toolhead (2) without having to separately press the release button (14), as the connecting pin (21b) would connect with the toolhead (2) at the same time it is inserted. However, it is appropriate that the length of the connecting pin (21b) be long as it is in the present embodiment, with the connecting pin (21b) connecting to the toolhead (2) via optional, intermittent movements of the connecting pin (21b) induced by the released button (14). The present invention is purposefully configured like the latter structure to allow the fastener (21), which is supported by the elastic body (22), to stably move upward. At this time, according to the present invention, the toolhead (2) can be fixed by the connection of the connecting pin (21b), with the toolhead (2) fitted into the socket (23c) of the connector (23). This way, according to the present invention, the connecting pin (21b) connected to the fixing hole (3) of the toolhead (2) prevents the toolhead (2) from sliding and helps stably fix the toolhead (2) in the body of the handle (10).

Furthermore, the connecting protrusions (4) of the toolhead (2) fit into the protuberance (23d) and the indentation (23e) of the slot (23c), providing additional connections.

Moreover, the multiple layer members of the coupler (20) supports all the sides (a total of 5 sides) of the toolhead (2) except for the part that extends tool-side; such a structure prevents the toolhead (2) from moving. Here, the connecting pin (21b) of the fastener (21) is inserted into the fixing hole (3) of the toolhead (2) and the first through hole (25b) of the first spacer (25), thus maintaining an even stabler connection to the toolhead (2). In other words, this foregoing structure prevents the fastener (21) from moving, maintaining a stable connection.

In addition, the first spacer (25) guides a part of the connecting pin (21b) to remain inside the first through hole (25b) even when the fastener (21) moves due to the release button (14) being pressed, thus preventing the connecting pin (21b) from completely deviating. Such a structure guides the release button (15) so that its upward movement is facilitated. In other words, the first spacer (25) guides the connecting pin (21b), providing a space for the fastener (21) to perform smoothly. Thus, according to the present invention, the connecting pin (21b) and the release pin (21c) are guided through and moved by various holes, inducing stable upward movements of the fastener (21).

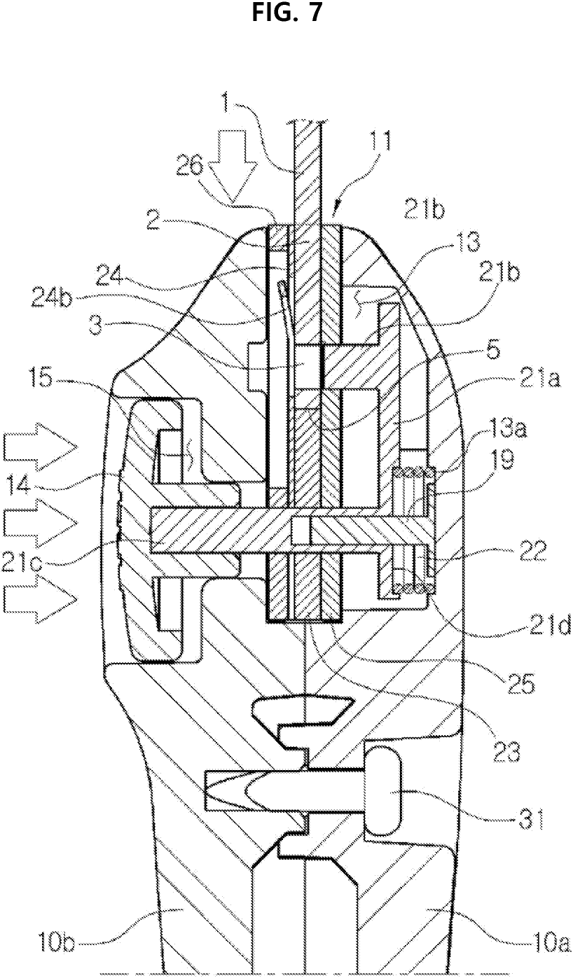

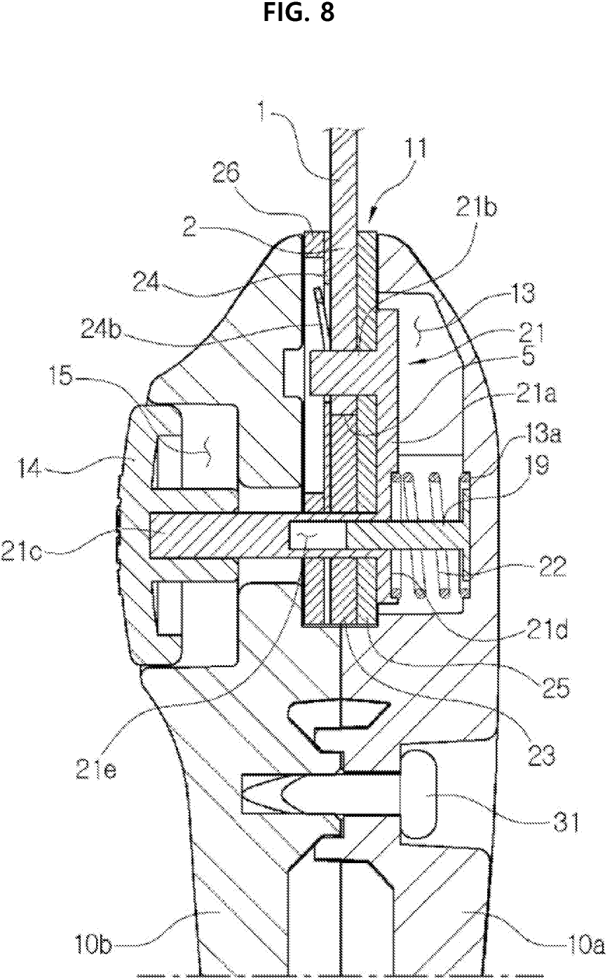

Here, according to the present invention, the notch part (N) and the notch grooves (H) prevent the lateral movement of the fastener (21) via the pin and layered members, which function to prevent movement. Meanwhile, when separating the toolhead (2) for tool replacement, simply pressing the release button (14) and disconnecting it from the connecting pin (21c) allows the user to pull out the toolhead (2) and separate it from the body of the handle (10) in the following order: FIG. 8, FIG. 7, then FIG. 6. Like this, the hand grip for tools defined by the present invention allows the toolhead (2) to be mounted and separated with ease, not only making it convenient to connect the working part and the grip part of a tool, but also stably fixing the components in place.

Furthermore, the invention is advantageous in the fact that it allows the user to easily change between tools thanks to its structure that facilitates connection and separation. Therefore, according to the hand grip for tools defined by this present invention, the grip is structured in a way such that the coupler (20) connects the toolhead (2) to the grip via pins, allowing the user to fix or separate the toolhead (2) without the need of additional tools.

Moreover, according to the present invention, such a structure involving pins stably fixes the toolhead (2) in place while preventing it from deviating or separating randomly. Consequently, the present invention allows the fastener (21) to be connected or disconnected with a simple touch of a button, facilitating rapid replacements of the working part.

Furthermore, according to the hand grip for tools defined by the present invention, the layer members are stacked on top of one another, with the two pins spaced apart, thus maintaining a stable connection while minimizing the lateral movement of the fastener (21) as it moves upward, increasing stability. In other words, the connection of the toolhead (2) is securely maintained. According to the hand grip for tools defined by the present invention, when connecting the toolhead (2) to the body of the handle (10), the toolhead (2) is guided and inserted into the space of insertion (S) provided by the port (11). After the toolhead (2) has been inserted, all contact surfaces of the toolhead (2) are supported by the space of insertion (S) while the fastener (21) and the connector (23) each remain fitted, thus improving the stability of the connected structure.

Moreover, according to the present invention, the fastener (21), upon being pressed, performs stably in its position as it moves upward, minimizing the chance of the fastener (21) having its movements limited or snagging on another component. Furthermore, the present invention is structured in a way that maintains the connection of the toolhead (2) via a structure involving pin fixations and fitting parts, and at the same time fixing the toolhead (2) in place via a structure in which the pressure plate (24) exerts pressure unidirectionally. Such a structure facilitates the replacement of the working part and allows for stable use of the tool, effectively preventing the separation of the working part and the grip part.

Further explanations can only be considered as mere exemplary delineations. To those generally skilled in the art pertaining to the present invention, the construction of the present invention can be modified and changed to the extent that the present invention does not deviate from essential characteristics. Therefore, the embodiments revealed in the present invention are not to limit the technological idea of the present invention, but to explain it. The scope of the technological ideas of the present invention are therefore not limited by the aforementioned embodiments.

Accordingly, while the invention has been shown and described with reference to different embodiments thereof, it will be appreciated by those skilled in the art that variations in form, detail, compositions and operation may be made without departing from the spirit and scope of the invention as defined by the accompanying claims.

### Description of Reference Number

1: tool 2: toolhead 3: fixing hole 4: connecting protrusion 5: short side 10: body of the handle 10a: first housing 10b: second housing 11: port 12: casing 13: pocket 14: release button 15: button mounting hole 16: magnet 17: strap hole 18: rubber part 19: guide pin 20: coupler 21: fastener 21a: base 21b: connecting pin 21c: release pin 22: elastic body 23: connector 23a: connector body 23b: recessed groove 23c: socket 231: first pin hole 24: pressure plate 24a: plate body 24b: push protrusion 24c: through hole 241: second pin hole 25: first spacer 25a: body 25b: first through hole 251: third pin hole 26: second spacer 26a: body 26b: through hole 261: fourth pin hole 31 primary fixed member 32: secondary fixed member

What is claimed is:

1. A hand grip for tools, comprising:
a body having a port that is formed on one side of the body and that a toolhead serving as one part of a tool is inserted into by connecting with the hand grip; and
a coupler installed inside the body and fixing the toolhead to the port in a removable way.

2. The hand grip for tools of claim 1, wherein the coupler comprises:
a fastener connected to the toolhead; and
an elastic body connected to the fastener to detach and move the said fastener in respect to the toolhead.

3. The hand grip for tools of claim 2, wherein the fastener comprises:
a base that is stacked on top of the elastic body, is accommodated inside the body, and is provided to be movable; and
a connecting pin that protrudes from one side of the base and is fitted into a hole formed on the toolhead.

4. The hand grip for tools of claim 3, wherein the coupler further comprises:
a layered connector that is stacked on the fastener and includes:
a recessed groove formed in an open manner to provide a space for the connecting pin to move; and
a socket that is formed on one side of the recessed groove and that the toolhead is fitted into.

5. The hand grip for tools of claim 4, wherein the coupler further comprises:
a layered pressure plate stacked on the connector and equipped with a push protrusion that protrudes from the pressure plate and that exerts pressure on one side of the toolhead fitted into the socket.

6. The hand grip for tools of claim 5, wherein the coupler further comprises:
a layered first spacer that is positioned between the fastener and the connector and provides a space through which the connecting pin can operate; and
a layered second spacer that is stacked on the pressure plate and provides a space for the push protrusion to act.

7. The hand grip for tools of claim 6, wherein the body comprises:
a casing that is open on one side of the body to accommodate the port and is extended inward from the port to accommodate a space in which the coupler is to be installed,
wherein the casing comprises a concave pocket that accommodates the fastener and the elastic body.

8. The hand grip for tools of claim 3, wherein the fastener comprises:
a release pin that protrudes from the base, is spaced apart from the connecting pin, and is characterized by a length thereof that is longer than that of the connecting pin.

9. The hand grip for tools of claim 8, wherein a release button is installed on an exterior of the body and is connected to the release pin to move the fastener by external pressure.

10. The hand grip for tools of claim 1, wherein the body features a flat bottom surface on an opposite side of the port, and the bottom surface is fitted with a magnet that allows a user to place an item on a surface of the magnet by magnetism.
